(19) United States
(12) Patent Application Publication
(10) Pub. No.: US 2012/0172164 A1
(43) Pub. Date: Jul. 5, 2012

(54) BICYCLE CHAIN CATCHER DEVICE

(75) Inventor: Stephan Vogt, Koblenz (DE)

(73) Assignee: Canyon Bicycles GmbH

(21) Appl. No.: 13/005,964

(22) Filed: Jan. 13, 2011

(30) Foreign Application Priority Data
Jan. 4, 2011 (DE) 20 2011 001 149.6

(51) Int. Cl. F16H 7/18

(52) U.S. Cl. 474/140

(57) ABSTRACT

A chain catcher device for bicycle chains, provided for preventing the bicycle chain from slipping off from an inner chain ring (34), comprises a fastening element (10) and a catching element (12). The fastening element serves for fastening the chain catcher device to the bicycle frame (24), particularly to fasteners for a bottle holder. For this purpose, the fastening element comprises two fastening means (14, 16; 18, 20) arranged at mutual distances on the fastening element.

### BACKGROUND OF THE INVENTION

1. Field of the invention

The present invention relates to a catcher device for bicycle chains which is provided to prevent the bicycle chain from slipping off from an inner chain ring.

2. Description of the prior art

In bicycles of the type comprising a plurality of chain rings, the process of switching from an outer, larger chain ring to an inner, smaller chain ring involves the danger that the chain may happen to slip off and thus drop in the region between the inner chain ring and the bicycle frame. As a consequence, the chain may get jammed. This may lead to severe falls. Even in such situations where the chain does not get jammed, the chain or the frame may suffer damage. For lifting the chain back onto the inner chain ring, the cyclist will in any case have to dismount. In bicycle races, such occurrences will cause considerable time losses. To keep the chain from slipping off the inner chain ring, catching devices are known, briefly referred to as chain catchers. These are connected to the saddle tube of the bicycle frame via a fastening element such as e.g. a clamp, and comprise a curved catching element connected to said clamp. Starting from the saddle tube, the catching element is curved in a direction toward the inner chain ring and is arranged at a close distance from the inner chain ring. Thereby, the risk is avoided that the chain might slip off from the inner chain ring during the switching process. However, chain catchers of the type fastened to the saddle tube with the aid of a clamp have the disadvantage that they may become twisted on the saddle tube, particularly under the influence of the forces and moments that occur when catching the chain. As a result, the functionality of the chain catcher cannot not guaranteed anymore. In certain cases, the chain may even grind against the inner chain ring or become jammed.

Further, corresponding catcher devices for bicycle chains are known which are connected to the derailleur base. The derailleur base is the component part carrying the derailleur and is attached to the saddle tube. Attachment to the derailleur base is provided via a screw so that also this arrangement entails the risk of a twisting of the chain catcher.

It is an object of the invention to provide a bicycle chain catcher device wherein the danger of twisting or displacement is reduced.

### SUMMARY OF THE INVENTION

According to the invention, the above object is achieved by the features defined in claim 1.

The bicycle chain catcher device of the invention, provided for preventing the bicycle chain from slipping off from an inner chain ring, comprises a fastening element for fastening the bicycle chain catcher device to the bicycle frame, particularly to the saddle tube of the bicycle frame. Connected to said fastening element is a catching element wherein, according to a preferred embodiment, the catching element and the fastening element are formed as one part. In the mounted state, the catching element is preferably curved, particularly convexly, in the direction toward the inner chain ring. In the mounted state, the catching element is arranged at an offset at least in the direction of the inner chain ring. Thus, the catching element is arranged closer to the chain ring than is the fastening element. Apart from preferably having a curved shape, the catching element can also consist of one or a plurality of linear individual elements. In order to avoid a twisting or shifting of the chain catcher device due to the occurrence of forces and moments during slip-off of the bicycle chain, the fastening element according to the invention comprises at least two fastening means. Via said two fastening means, the chain catcher device is fastened to the saddle tube of the bicycle frame. The provision of at least two fastening means has the advantage of reducing the danger of twisting or shifting even upon occurrence of indeed relatively large forces and moments.

According to a particularly preferred embodiment, said two fastening means are arranged at a close distance from each other. Particularly, the two fastening means are arranged at different height positions relative to the saddle tube of the bicycle frame.

In the above regard, it is particularly preferred that the distance between the two fastening means is selected to correspond to the distance between the fasteners for the bottle-holder. This a makes it possible to fasten the inventive chain catcher device to the bottle-holder fastener arrangement on the bicycle frame. The bottle-holder fastener arrangement usually comprises two threads formed in the saddle tube, thus allowing the chain catcher device to be fastened by means of two screws. In this regard, it is possible to utilize the bottle-holder fastener arrangement exclusively for attachment of the chain catcher device or for attachment of the chain catcher device and the bottle holder alike. In the latter case, it will merely be required to use somewhat longer screws.

It is particularly preferred that the chain catcher device comprises fastening means only in the form of holes or openings which will then serve for attachment to the saddle tube with the aid of screws, rivets or the like.

In the above arrangement, the upper or lower one of the two fastening means is preferably formed as a longitudinal hole. The orientation of the optionally slightly curved longitudinal hole is preferably such that its longitudinal direction is arranged horizontally. Thus, the longitudinal hole is arranged substantially transversely to the longitudinal direction of the frame or, in other words, transversely to the riding direction. Thereby, it is rendered possible, particularly in case of an attachment to the bottle-holder fastener, to pivot the chain catcher device about the lower or the upper fastening means, e.g. a round hole, and then to fix the chain catcher device to the upper or lower fastening means, i.e. the longitudinal hole, with the aid of a screw. In this manner, the distance between the catching element and the inner chain ring can be precisely adjusted.

According to another particularly preferred embodiment of the invention, at least one further pair of fastening means is provided in addition to the first pair of fastening means. Also said further pair of fastening means preferably comprises two holes, wherein, also herein, the upper or lower fastening means is preferably formed as a horizontally oriented longitudinal hole. As a result, the chain catcher device can be used for different combinations of frames and chain rings.

Since, according to a particularly preferred embodiment, the attachment is realized via two screws on the saddle tube, particularly on the already existing bottle-holder fastener arrangement, the bending moment generated by the chain when the latter slips off can be reliably introduced into the frame without occurrence of twisting or shifting of the frame.

The above attachment of the chain catcher device via two fastening means, particularly screws, to the existing bottle-holder fastener arrangement has the further advantage of allowing the chain catcher device to be fastened to the saddle tube irrespective of the cross section of the saddle tube. This is beneficial particularly in carbon frames because these often have a non-round cross section which is adapted to the loads. Further, if clamps were attached to carbon frames, this would entail a risk of notch effects with a resultant possibility of damage to the carbon fibers.

The catching element preferably comprises a planar catching surface facing in the direction of the inner chain ring. Said catching surface can have a slight convex curvature in the moving direction of the chain so as to avoid damage caused by jamming. Further, it is preferred that a reinforcing web is provided on a rear side of the catching element facing away from the chain ring, for thus avoiding deformation of the catching element.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 is a schematic plan view of the chain catcher device;

FIG. 2 is a schematic lateral view as seen in the direction marked by arrow II in FIG. 1; and

FIG. 3 is a schematic plan view of the chain catcher device in the mounted state.

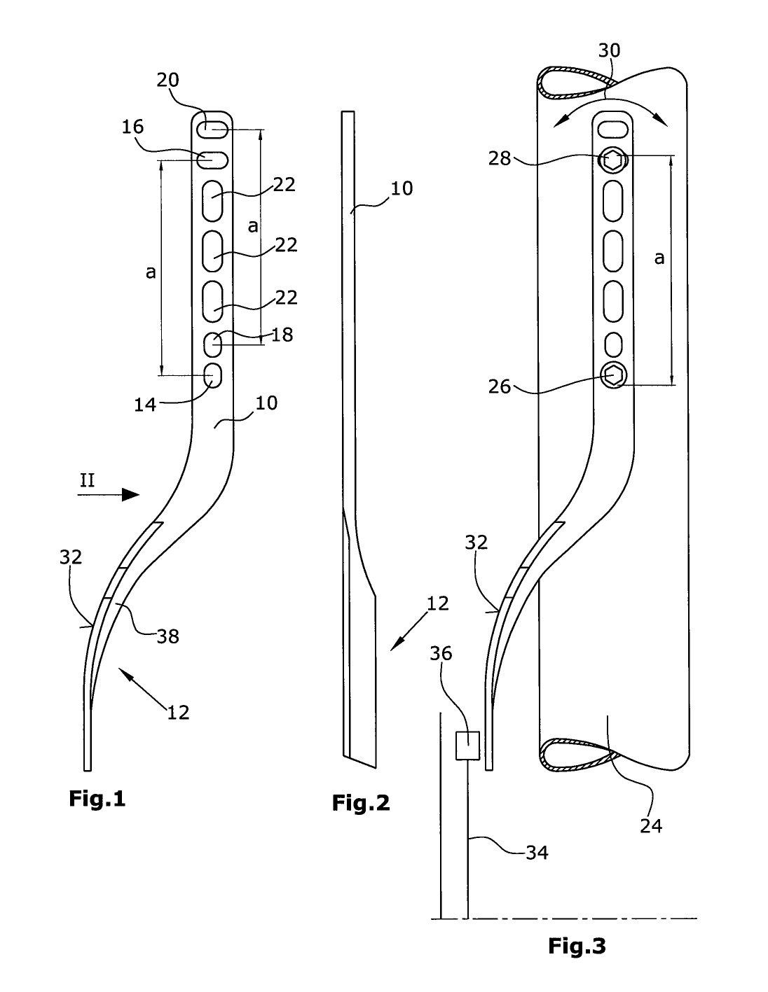

### DETAILED DESCRIPTION OF PREFERRED EMBODIMENTS

The chain catcher device of the invention comprises a web-shaped fastening element 10 which is formed integrally with a catching element 12. Said fastening element 10 is formed substantially as a flat member made particularly of a metal sheet. Fastening element 10 comprises a first pair of fastening means 14, 16 and a second pair of fastening means 18, 20. In the illustrated embodiment, said fastening means 14, 16, 18, 20 are realized in the form of holes in fastening element 10. Between said fastening means 14, 16, 18, 20, further cutouts 22 are provided which, however, serve only for weight reduction.

The two pairs of fastening means 14, 16 and 18, 20 each have the same distance a between themselves. Said distance a corresponds to the distance between the fasteners for the bottle holder which are provided on a saddle tube 24 (FIG. 3). Said bottle-holder fasteners usually are realized as inner threads cut into the saddle tube, or as inserted threaded sleeves.

By the provision of two pairs of fastening means 14, 16 and 18, 20, it is rendered possible to connect the chain catcher device to the saddle tube 24 at different positions. In this manner, different combinations of the frame and chain rings are possible.

The upper fastening means 16, 20 are preferably formed as longitudinal holes, wherein the longitudinal dimension of these longitudinal holes preferably extends horizontally. This makes it possible to fix the chain catcher device in position via a lower screw 26 (FIG. 3) and one of said holes 14 or 18 and, prior to the second fixing with the aid of the screw 28, to pivot the chain catcher device (arrows 30). In this manner, the distance between a chain catching surface 32 of catching element 12 and an inner chain ring 34 can be precisely set.

The catching element 12 is convexly curved towards said inner chain ring 34 and, according to a preferred embodiment, comprises a plane catching surface 32. Said catching surface 32 can be slightly convexly curved in the longitudinal direction of a chain 36 so that, should the chain 36 slip off, damage to the chain 36 caused by jamming will be prevented.

On a rear side of catching element 12, a reinforcement web 38 is provided to avoid a bending distortion of catching element 12.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A chain catcher device for bicycle chains, provided for preventing the bicycle chain from slipping off from an inner chain ring, said chain catcher device comprising
a fastening element for fastening the chain catcher device to the bicycle frame, and
a preferably curved catching element which is connected to said fastening element and in the mounted state is arranged at a displacement toward said inner chain ring, wherein
said fastening element comprises at least two fastening means for attachment to the bicycle frame.

2. The chain catcher device according to claim 1, wherein said fastening means are arranged at a distance to each other, particularly at different height positions along a saddle tube of the bicycle frame.

3. The chain catcher device according to claim 1, wherein the distance between the fastening means corresponds to the distance between the fasteners for a bottle holder which are provided on the saddle tube.

4. The chain catcher device according to claim 1, wherein the upper fastening means are formed as longitudinal holes, the longitudinal dimension of said longitudinal holes preferably extending horizontally.

5. The chain catcher device according to claim 1, wherein at least one further pair of fastening means is provided for fastening the chain catcher device at different vertical positions, particularly on said fastening arrangement for a bottle holder.

6. The chain catcher device according to claim 1, wherein the catching element comprises a catching surface facing toward the inner chain ring.

7. The chain catcher device according to claim 1, wherein the catching element comprises a reinforcement web on a rear side facing away from the chain ring.
